(19) United States
(12) Patent Application Publication
(10) Pub. No.: US 2026/0059446 A1
(43) Pub. Date: Feb. 26, 2026

(54) WAKEUP SIGNAL (WUS) TRIGGERED UPLINK BEAM REPORTS

(71) Applicant: QUALCOMM Incorporated, San Diego, CA (US)

(72) Inventors: Kiran VENUGOPAL, Green Brook, NJ (US); Yan ZHOU, San Diego, CA (US); Yu ZHANG, San Diego, CA (US); Jing SUN, San Diego, CA (US)

(21) Appl. No.: 18/809,774

(22) Filed: Aug. 20, 2024

(51) Int. Cl. H04W 52/02; H04B 17/318; H04L 5/00; H04W 76/28

(52) U.S. Cl. CPC H04W 52/0235; H04B 17/318; H04L 5/0051; H04W 76/28

(57) ABSTRACT

Certain aspects of the present disclosure provide a method for wireless communications at a user equipment (UE). The UE may receive a wakeup signal (WUS) from a gNodeB (gNB). The WUS may indicate that the UE has to wakeup and monitor for downlink transmissions during a subsequent discontinuous reception (DRX) on-duration period. The WUS may also indicate a time and frequency resource for transmitting a report. The UE may measure beam strength of uplink beams. The UE may transmit the report indicating the beam strength of each of the uplink beams on the time and frequency resource indicated via the WUS.

### BACKGROUND

### Field of the Disclosure

Aspects of the present disclosure relate to wireless communications, and more particularly, to techniques for managing uplink beam reports.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes receiving a wakeup signal (WUS) indicating the UE is to wakeup and monitor for downlink transmissions during a subsequent discontinuous reception (DRX) on-duration period. The method further includes transmitting a report indicating beam strength of each of one or more uplink beams, in response to receiving the WUS.

Another aspect provides a method for wireless communications at a network entity. The method includes transmitting a WUS indicating a UE is to wakeup and monitor for downlink transmissions during a subsequent DRX on-duration period. The method further includes receiving a report indicating beam strength of each of one or more uplink beams, in response to transmitting the WUS.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIG. 4A, FIG. 4B, FIG. 4C, and FIG. 4D depict various example aspects of data structures for a wireless communications network.

FIG. 5 depicts example connected-mode discontinuous reception (CDRX) operations.

FIG. 6 depicts example CDRX with beamforming.

FIG. 7 depicts example CDRX with wakeup signals (WUS).

FIG. 8 depicts example CDRX with beamformed WUS.

FIG. 9 depicts example WUS system operations.

FIG. 10 and FIG. 11 depict example reference signals or beams reported by a UE to a gNodeB (gNB).

FIG. 12 depicts example beam report indicating multiple downlink beams and uplink beams.

FIG. 13 depicts a call flow diagram illustrating example communication among wireless nodes (e.g., a UE and a gNB) for managing uplink beam reports.

FIG. 14 depicts example WUS triggering a UE to send an uplink beam report on a resource indicated by the WUS.

FIG. 15, FIG. 16, and FIG. 17 depict different fields in a WUS.

FIG. 18 depicts a method for wireless communications at a wireless node such as a UE for managing uplink beam reports.

FIG. 19 depicts a method for wireless communications at a wireless node such as a network entity for managing uplink beam reports.

FIG. 20 and FIG. 21 depict example communications devices for managing uplink beam reports.

### DETAILED DESCRIPTION

Aspects of the present disclosure provide apparatuses, methods, processing systems, and computer-readable mediums for managing uplink beam reports.

In new radio (NR) systems, a user equipment (UE) may be configured with a discontinuous reception (DRX) operation. For example, the UE may be configured to periodically turn ON for monitoring a downlink control channel from a gNodeB (gNB) and turn OFF (or sleep) on other times.

A wakeup signal (WUS) may be used for saving power of the UE. For example, the gNB transmits the WUS to the UE only when there is paging for the UE. Paging is a mechanism used to notify an idle UE about incoming data, call requests, or network updates. Upon detecting the WUS, the UE wakes up to receive data during a next on-duration period of a DRX cycle. When the WUS is not detected by the UE, the UE may continue to sleep during the next on-duration period of the DRX cycle.

Beam management is a set of layer 1 and layer 2 procedures to establish and retain an optimal beam pair for good connectivity. A beam pair consists of a transmit beam and a corresponding receive beam in one link direction. The beam management may include beam measurement and detection, and beam reporting. For example, the UE may measure beam strength of multiple beams (e.g., uplink beams, downlink beams) by measuring their received signal power. The UE may then have to transmit a beam report to the gNB which may include beam strength information of the multiple beams.

Techniques described herein may define triggering conditions and resources for transmitting an uplink beam report to a gNB (e.g., during an on-duration period of a DRX cycle configured for a UE). The uplink beam report may indicate beam strength information of each of multiple uplink beams. For example, detection of a WUS from the gNB may trigger the UE to generate and transmit the uplink beam report. The WUS may indicate resources to be used for transmitting the uplink beam report. So, upon detection of the WUS, the UE transmits the uplink beam report to the gNB on the resources indicated by the WUS during the on-duration period of the DRX cycle.

Particular aspects of the subject matter described in this disclosure can be implemented to realize one or more of the following potential advantages. In some examples, the described techniques may reduce latency as the UE is able to immediately transmit the uplink beam report to the gNB upon entering the on-duration period of a DRX cycle.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

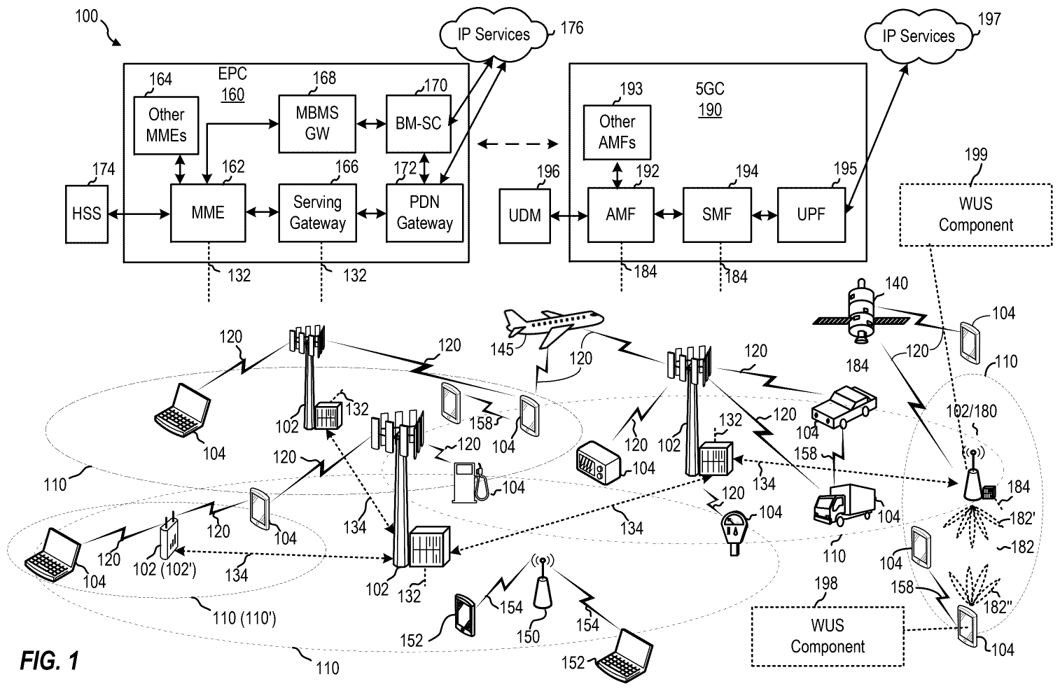

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

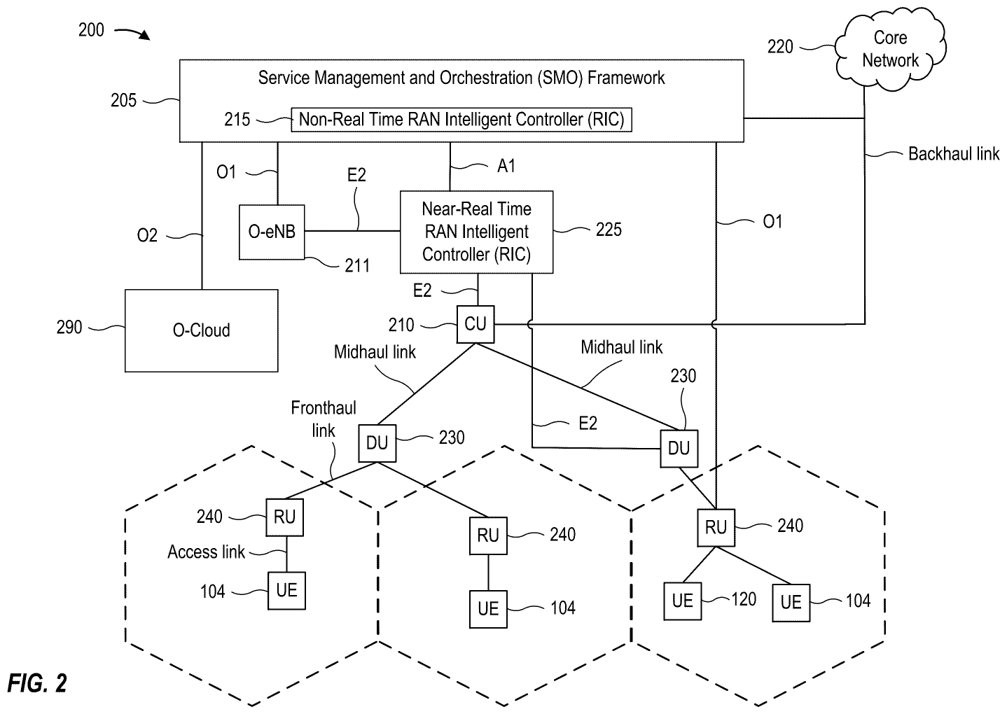

While BSs 102 are depicted in various aspects as unitary communications devices, BSs 102 may be implemented in various configurations. For example, one or more components of a BS 102 may be disaggregated, including a central unit (CU), one or more distributed units (Dus), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 130) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mmWave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

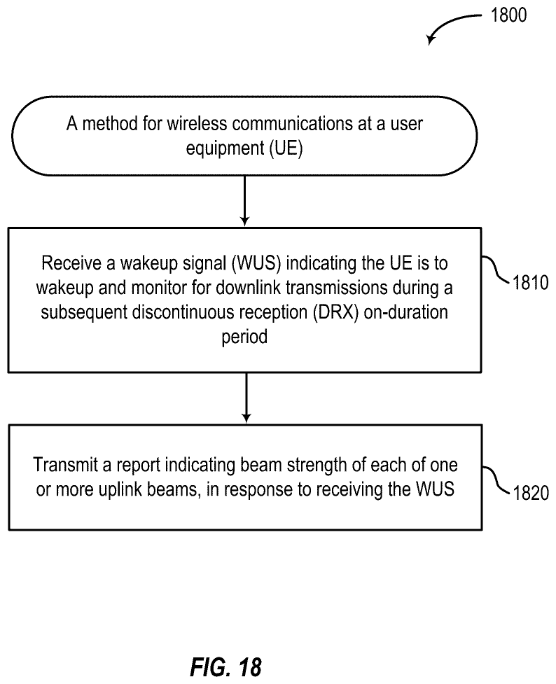

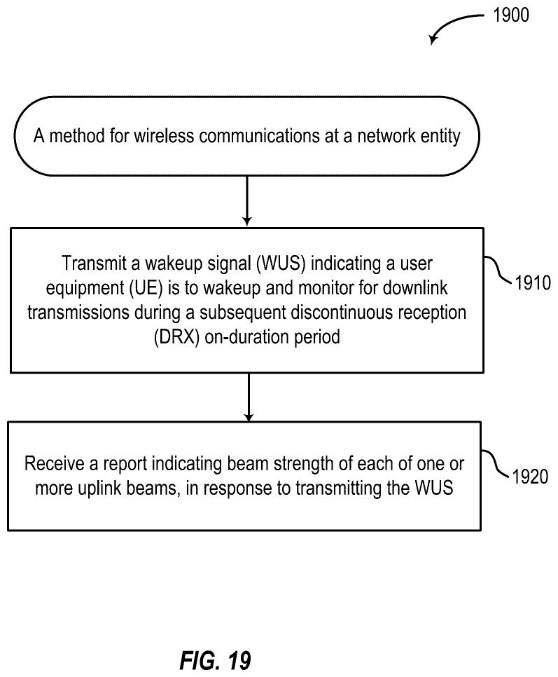

Wireless communication network 100 further includes wakeup signal (WUS) component 198, which may be configured to perform method 1800 of FIG. 18. Wireless communication network 100 further includes WUS component 199, which may be configured to perform method 1900 of FIG. 19.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (Dus) 230 via respective midhaul links, such as an F1 interface. The Dus 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

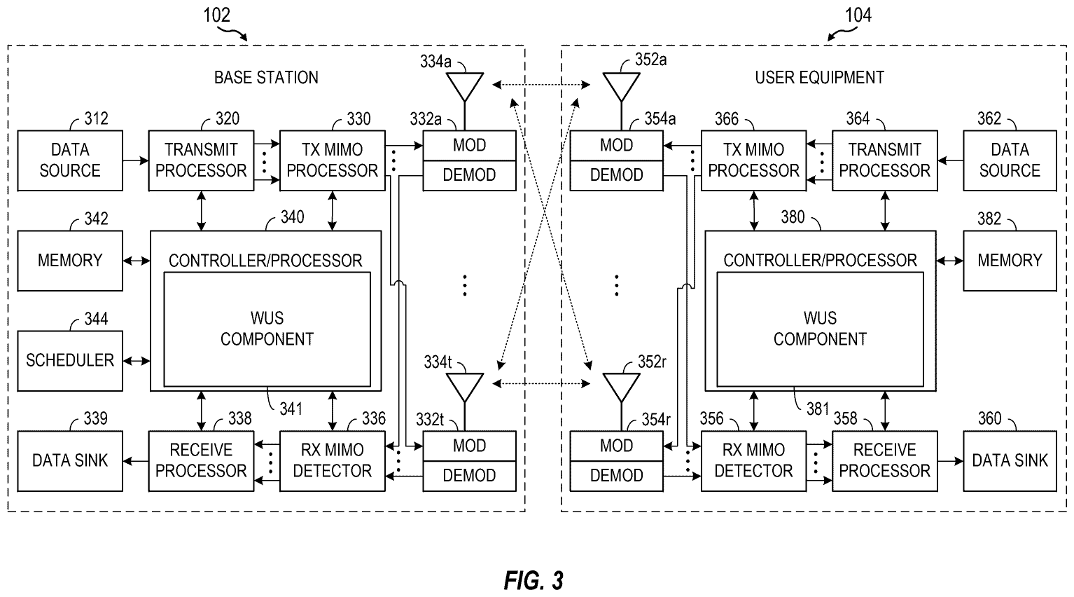

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes WUS component 341, which may be representative of WUS component 199 of FIG. 1. Notably, while depicted as an aspect of controller/processor 340, WUS component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes WUS component 381, which may be representative of WUS component 138 of FIG. 1. Notably, while depicted as an aspect of controller/processor 380, WUS component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the SRS). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs 104 for data transmission on the downlink and/or uplink.

In various aspects, BS 102 may be described as transmitting and receiving various types of data associated with the methods described herein. In these contexts, “transmitting” may refer to various mechanisms of providing or outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

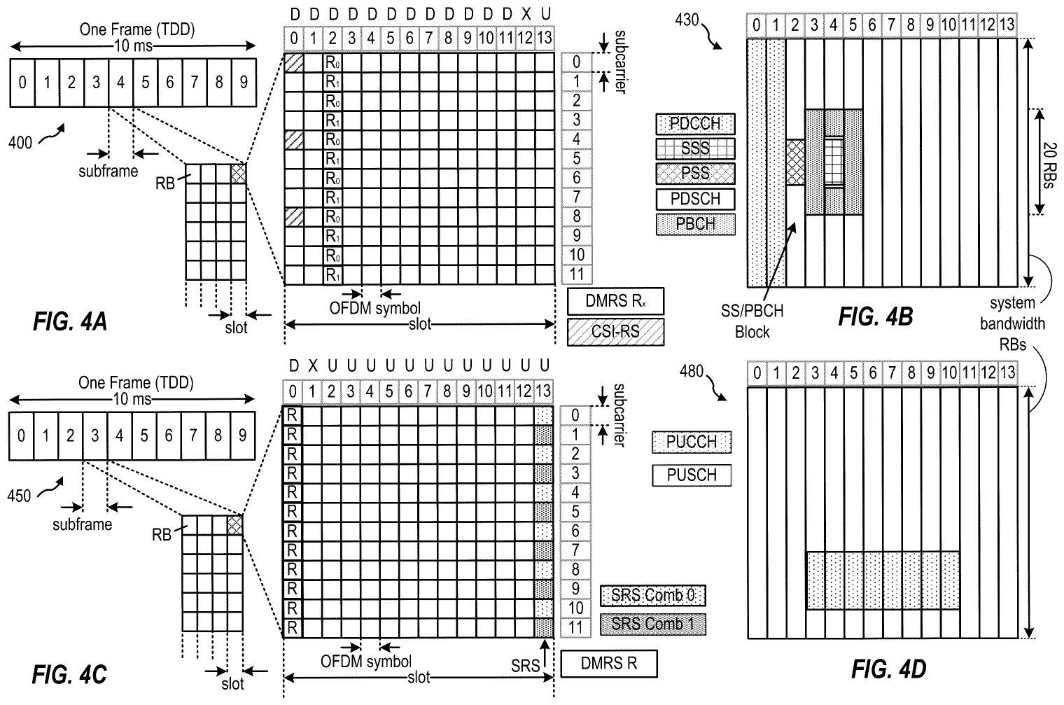

FIG. 4A, FIG. 4B, FIG. 4C, and FIG. 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIG. 4B and FIG. 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be TDD, in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs 104 may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μslots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIG. 4A, FIG. 4B, FIG. 4C, and FIG. 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIG. 4A, FIG. 4B, FIG. 4C, and FIG. 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIG. 1 and FIG. 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIG. 1 and FIG. 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Mmwave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3^{rd} generation partnership project (3GPP) standards. For example, 3GPP technical standard TS 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mmWave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of Beamforming

In millimeter wave (mmW) systems, beamforming technologies are used to increase array gain/antenna array gain. For example, devices such as user equipments (UEs) and network entities (e.g., a gNodeB (gNB)) using wireless communication technologies may include multiple antenna arrays. Each antenna array may include one or more transmission and reception antennas that can be co-phased and are configured to transmit and receive communications over one or more spatial streams/beams. The use of the multiple antenna arrays may afford the ability to meet spherical coverage requirements with/without hand/body blockage as well as robustness with beam switching over the antenna arrays.

Increases in the array gain facilitate a better quality of signal transmission and reception. To provide the array gain in a particular direction, beamforming is considered. Beamforming is a technique that utilizes advanced antenna technologies on both UEs and gNBs to focus a wireless signal according to a set of beam weights (e.g., in a specific direction), rather than broadcasting to a wide area. For beamforming at a UE, it usually includes a UE receive (Rx) beam sweep from a set of different beams. Beamforming may improve signal-to-noise ratio (SNR) of received signals, eliminate undesirable interference sources, and focus the transmitted signals to specific locations.

Beamforming is also performed to establish a link between the gNB and the UE, where both these devices form a beam directed towards (but not limited to this possibility) each other. For example, both the gNB and the UE find at least one adequate beam to form a communication link between each other. gNB-beam and UE-beam form what is known as a beam pair link (BPL). As an example, on a downlink, the gNB uses a transmit beam and the UE uses a receive beam corresponding to the transmit beam to receive a downlink transmission. The combination of the transmit beam and the corresponding receive beam is the BPL.

### Overview of Beam Management

Beam management is a set of layer 1 and layer 2 procedures to establish and retain an optimal beam pair for good connectivity. A beam pair consists of a transmit beam and a corresponding receive beam in one link direction. Before a user equipment (UE) can communicate with a gNodeB (gNB), it must perform cell search and selection procedures and obtain initial cell synchronization and system information.

In the case of a multi-antenna system that transmits multiple beams, detecting beams from the gNB is also a part of an initial procedure where the UE detects all the beams in a search space.

A set of beam management procedures are applicable for both modes (idle mode and connected mode) of operation.

Idle mode: This is when the UE does not have active data transmission. Idle mode procedure is used when the UE is trying to connect to the gNB for a first time while switching on or reinitiating connection after waking up. Beam management in the idle mode will help in establishing a directional initial access.

Connected mode: This is when active data exchange is taking place between the UE and the gNB and the UE is moving within a cell. In this mode, there is a high chance of signal deteriorating rapidly due to characteristics of mmWave, so managing a beam in real time will help in maintaining a healthy link.

Various aspects of the beam management may include beam sweeping, beam measurement and detection, beam reporting, beam recovery, and beam switching.

Beam sweeping is used during an initial access by the UE to choose a best beam. The gNB transmits the beams in all directions in a burst at regular defined intervals. Whenever the UE is synchronizing with the gNB, the UE reads an synchronization signal block (SSB) and extracts a primary synchronization signal (PSS) (e.g., one of three possible sequences, provides timing estimate), a secondary synchronization signal (SSS) (e.g., one of 336 possible sequences, provides cell ID (one of 3*336=1008)), a physical broadcast channel (PBCH) and demodulation reference signal (DMRS) (e.g., contains master information block (MIB), includes basic information to take a next step, which is to decode the system information block (SIB)-1).

For the beam measurement and detection, the UE measures beam strength of a beam by measuring received signal power. In idle mode it is based on the synchronization signals, and in connected mode it is based on a channel state information reference signal (CSI-RS) in downlink and a sounding reference signal (SRS) in uplink. The UE searches for a best beam periodically using a predefined threshold criteria defined by the gNB and identifies the best beam that has a highest reference signal received power.

The best beam identified by the UE is informed to the gNB and this process is called the beam reporting. A random access channel (RACH) is an uplink channel used during the initial access or when mobile is out of sync with the gNB and needs to establish synchronization. In idle mode, after the UE selected the beam, there is one or more RACH intervals for the UE with a certain time and frequency offset, which it transmits the RACH preamble. The UE transmits a physical RACH (PRACH) preamble corresponding to an SSB for which the best beam was identified. There is a one-to-one mapping between the received SSB and the transmitted RACH preamble. This is a way for the UE to report the best beam to the gNB. The gNB configures the UE to perform certain measurements and report them on a preconfigured interval and this process is called measurement reporting. In connected mode, when the UE is already connected with the gNB and active data transfer is taking place, the UE reports the beam through a measurement report to the gNB.

In the case of a beam failure due to poor channel condition, a beam recovery process is triggered to get back a new beam. The UE monitors a reference signal and identifies the beam failure once the beam failure trigger conditions are met. The UE chooses a next best beam for sending in a random access (RA) preamble when the beam failure happens. If first attempt of RA fails, the UE sweeps to another beam for another RA procedure. The RA preamble is sent in the PRACH. The UE receives a downlink resource allocation and an uplink grant on a physical downlink control channel (PDCCH).

Switching from one beam to another can also be called intra-cell mobility or beam-level mobility. Beam switching is based on a trigger condition for a beam and a configured beam switching algorithm. This is applicable when the UE is in a connected mode and can be done through layer 1/layer 2 procedures. On the other hand, handover is for inter-cell mobility and is a layer 3 procedure.

### Overview of Discontinuous Reception (DRX) Operations

Discontinuous reception (DRX) is a power-saving mechanism used in communication systems to extend a battery life of a wireless node such as a user equipment (UE). The DRX mechanism may be used by UEs to periodically turn off their receivers and enter a low-power state, waking up only at specific intervals to check for incoming data or signals. This helps in reducing power consumption during periods of inactivity.

A DRX cycle defines a duration for which the UE remains in an active state before entering a low-power state. The DRX cycle may be divided into on-duration (active state) and off-duration (low-power state).

A long DRX cycle may refer to a DRX configuration with a longer cycle duration, which is suitable for scenarios where the UE can afford to stay in a low-power state for extended periods. A short DRX cycle may refer to a DRX configuration with a shorter cycle duration, suitable for scenarios where the UE needs to be more responsive and cannot afford long periods of inactivity.

In connected mode, where the UE is actively communicating with a network entity, connected-mode discontinuous reception (CDRX) allows the UE to periodically switch between active and low-power states. This is particularly useful when the UE expects incoming data but wants to conserve power during idle periods.

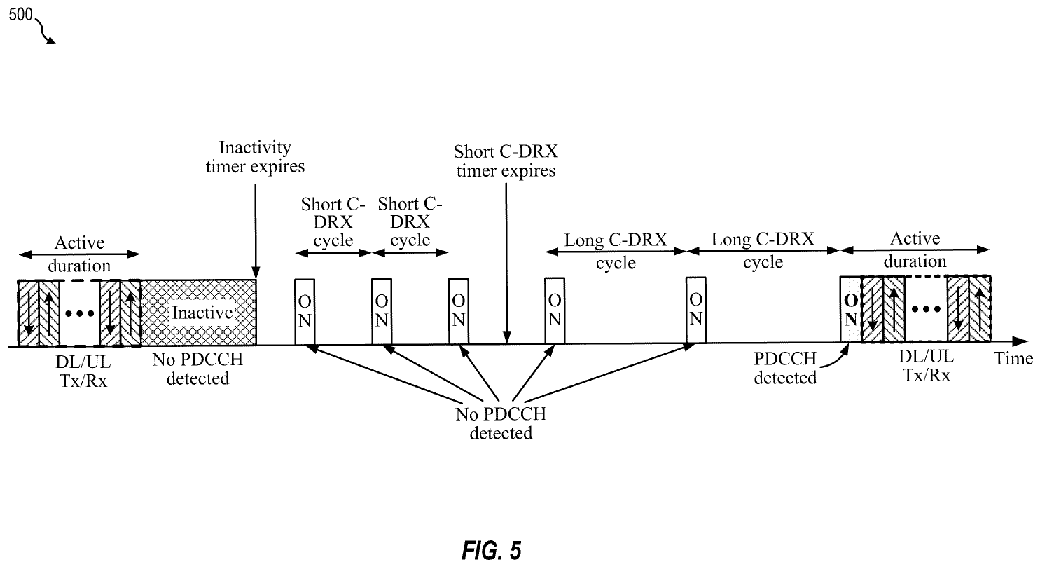

FIG. 5 depicts example CDRX operations. As illustrated in example timing diagram 500 of FIG. 5, during periods of traffic inactivity, a UE may switch to CDRX operation for power saving. In CDRX, when there is no data transmission in either direction (uplink (UL)/downlink (DL)) for a UE in an RRC connected mode, the UE goes into a DRX mode. In CDRX, the UE monitors a physical downlink control channel (PDCCH) channel discontinuously. In other words, the UE alternates between sleep (DRX OFF) cycles and wake (DRX ON) cycles. CDRX results in power savings because, without the DRX cycles, the UE would needlessly monitor for PDCCH transmissions in every subframe to check if there is downlink data available.

The UE may be configured for CDRX according to various configuration parameters, such as an inactivity timer, a short DRX timer, a short DRX cycle, and a long DRX cycle.

As illustrated in FIG. 5, based on configured cycles, UE wakes up occasionally for ON durations and monitors for PDCCH transmissions. Except for ON durations, the UE may remain in a low power (sleep) state referred to as an OFF duration, for the rest of CDRX cycle. During the OFF duration, the UE is not expected to transmit and receive any signal.

The UE may wakeup at a termination of CDRX mode. For example, if the UE detects a PDCCH scheduling data during an ON duration, UE remains on to transmit and receive data. Otherwise, the UE goes back to sleep at the end of the ON duration.

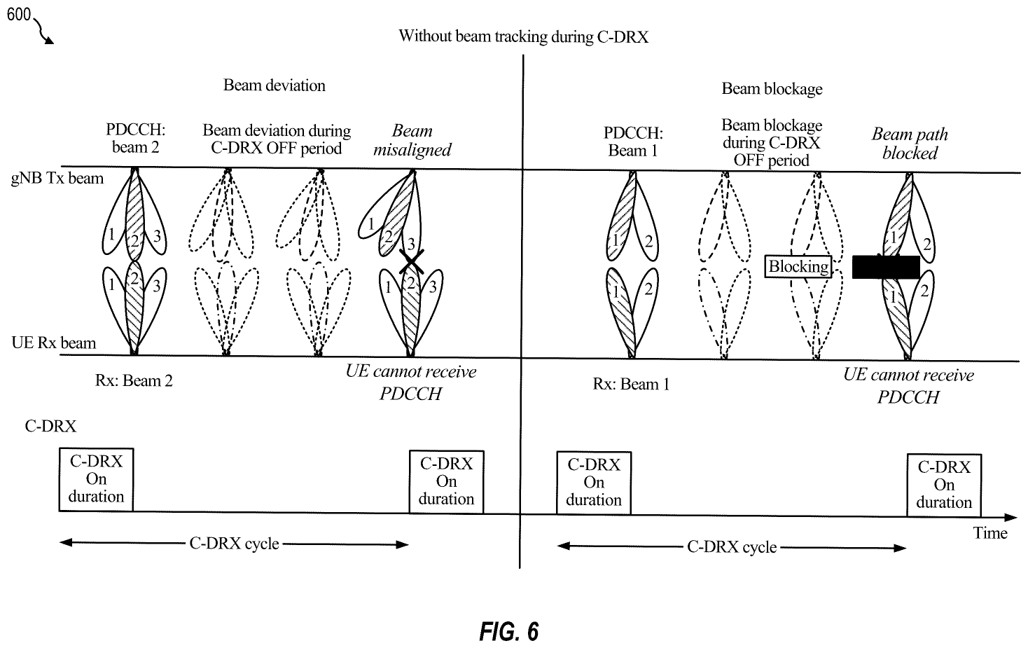

FIG. 6 depicts example CDRX with beamforming. As illustrated in example timing diagram 600 of FIG. 6, to enhance possibility or reaching a UE, beamforming may be used with the CDRX. While beamforming may enhance communications, it is not without challenges. For example, without beam tracking, beam pairs may degrade during a CDRX OFF period. The longer a CDRX cycle, the more vulnerable transmissions are to beam degradation. While shorter CDRX cycles may be less prone to beam degradation, shorter periods suffer from a power consumption penalty.

As illustrated in FIG. 6, due to beam deviation by UE orientation change or mobility (or beam blocking or maximum permissible exposure (MPE), etc.), the UE may not be able to receive PDCCH in the beginning of a next CDRX ON duration and fail to wake-up.

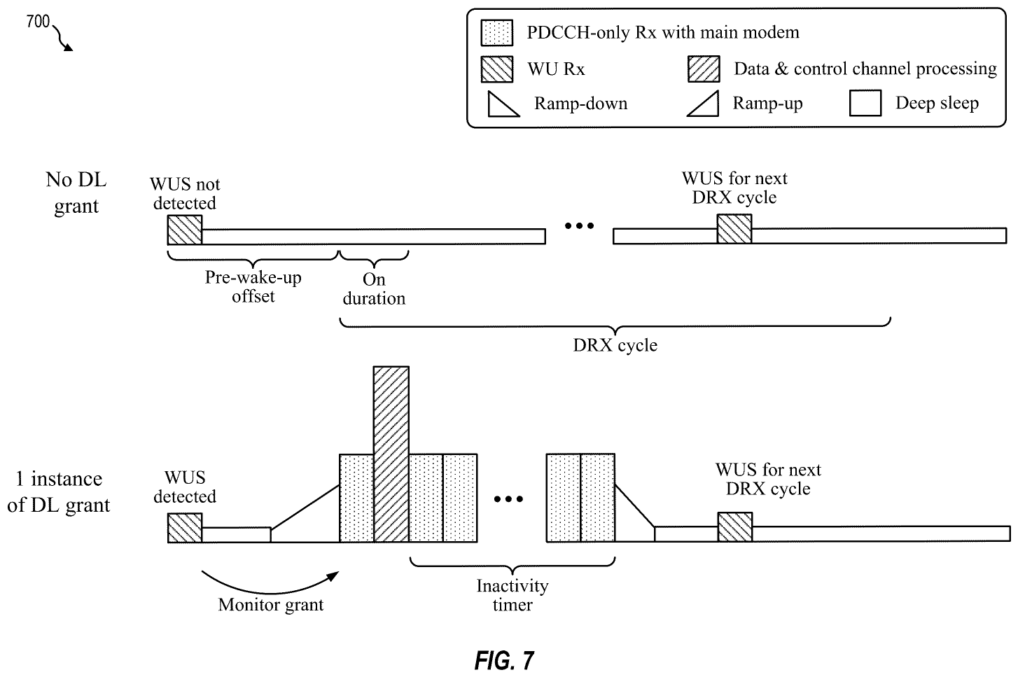

In some cases, sleep (OFF) durations may be extended using wakeup signals (WUS). The general principle of WUS in CDRX is illustrated in example timing diagram 700 of in FIG. 7.

As illustrated, before CDRX ON duration, only a wakeup subsystem is turned on for WUS decoding (e.g., while a main modem of the UE is not powered on). The wakeup subsystem is a low complexity receiver (e.g., a simple correlator) using a lower power than PDCCH decoding. The WUS may be a special waveform, such as special tone, preamble, reference-signal, or the like.

In some cases, only when WUS is detected, the UE wakes-up its full modem for a next ON duration. Otherwise, the UE skips the ON duration and goes back to sleep until a next CDRX cycle.

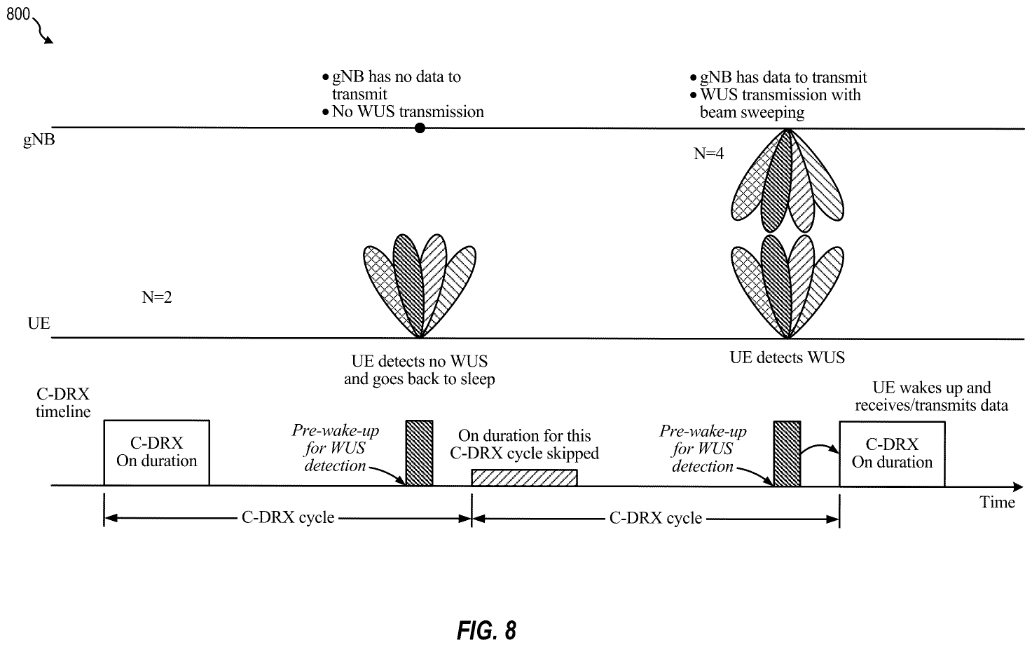

FIG. 8 depicts example CDRX with beamformed WUS. As illustrated in example timing diagram 800 of FIG. 8, beamforming may be applied to WUS transmissions. For example, a set of N (e.g., out of up to 64 synchronization signal blocks (SSBs)) beams may be configured for a UE. The value of N, and directions of the N beams, may be UE (or group)-specifically determined by gNodeB (gNB) (e.g., as a function of link quality, UE mobility, UE capability, CDRX cycle length, etc.).

### Aspects Related to WUS Triggered Uplink Beam Reports

In new radio (NR) systems, a user equipment (UE) may be configured with a connected-mode discontinuous reception (CDRX) operation during which the UE periodically turns ON its radio for monitoring a downlink control channel from a gNodeB (gNB) and turns OFF its radio on other times.

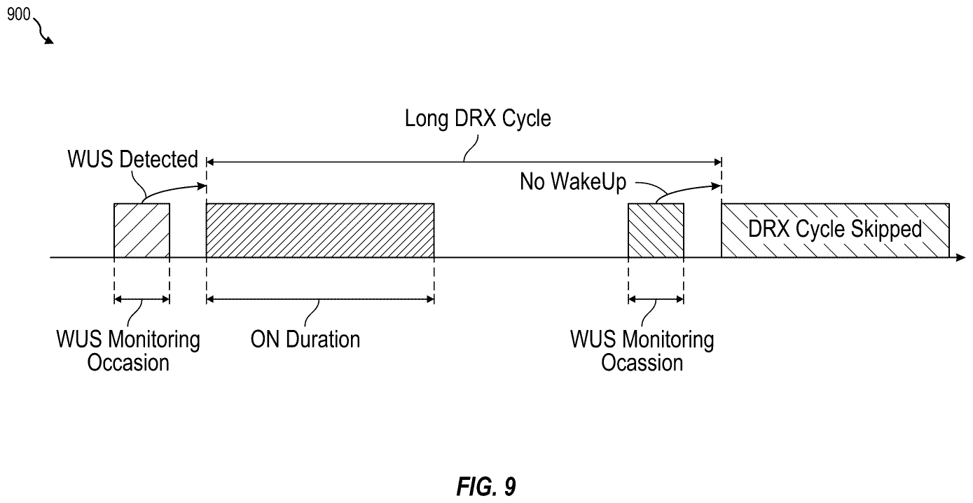

A wakeup signal (WUS) may be used for saving battery power of the UE. For example, as illustrated in a diagram 900 of FIG. 9, the gNB transmits the WUS to the UE, on a physical downlink control channel (PDCCH) using a downlink control information (DCI) format 2_6, only when there is paging for the UE. Paging is a mechanism used to notify an idle UE about incoming data, call requests, or network updates. The UE detects the WUS in a WUS monitoring occasion. Upon detection of the WUS, the UE wakes up to receive data during a next on-duration period of a discontinuous reception (DRX) cycle. When the WUS is not detected by the UE in the WUS monitoring occasion or the detected WUS indicates the UE not to wakeup, the UE may continue to sleep during the on-duration period of the DRX cycle and save power. Such two-stage wakeup of the UE facilitates higher power saving.

The gNB may configure the UE to report a channel state information (CSI) feedback and/or a beam/cell report to the gNB during the on-duration period of the DRX cycle.

The CSI feedback may include CSI parameters such as a channel quality indicator (CQI), a precoding matrix indicator (PMI), and a rank indicator (RI) that are related to a state of a channel between the UE and the gNB. The UE may process a channel state information—reference signal (CSI-RS) from the gNB to measure the CSI parameters. The gNB, upon receiving the CSI feedback from the UE, may schedule downlink data transmissions (such as a modulation scheme, a code rate, a number of transmission layers, and multiple input multiple output (MIMO) precoding) accordingly.

The beam/cell report may indicate one or more beams/cells. The beam/cell report may be based on downlink transmission metrics and not uplink transmission metrics. So, a beam/cell indicated in the beam/cell report that may be selected the gNB for uplink and downlink operations may not be good for an optimal uplink transmission performance.

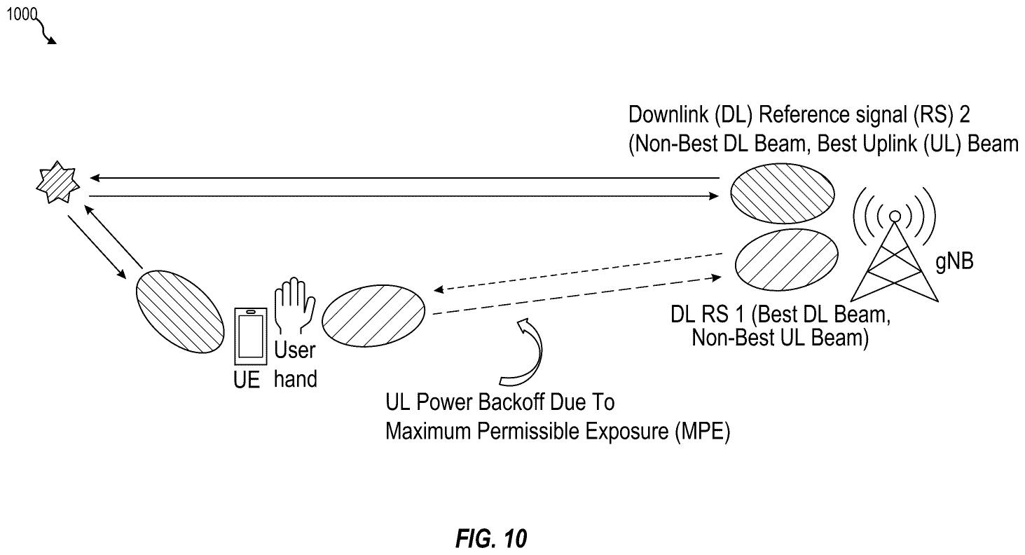

For example, as illustrated in a diagram 1000 of FIG. 10, the UE reports (e.g., in the beam/cell report) two downlink reference signals (or beams). The downlink reference signals may correspond to narrow CSI-RS beams (e.g., quasi co-located (QCLed) with a same synchronization signal block (SSB) beam) or different SSB beams. A first reference signal may have a best or a good downlink reference signal received power (e.g., when received at the UE from the gNB), but may have a non-best or not good uplink reference signal received power (e.g., during possible or expected transmission from the UE to the gNB due to uplink power back off (which may be due to a blockage device (e.g., a hand of a user or any other device)) for a maximum permissible exposure (MPE)). A second reference signal may have a non-best downlink reference signal received power (e.g., when received at the UE from the gNB) but a best uplink reference signal received power (e.g., during possible or expected transmission from the UE to the gNB without the uplink power back off for the MPE). Without information associated with the uplink transmission metrics (e.g., uplink reference signal received power) being reported to the gNB, the gNB may select the first reference signal (e.g., based on its downlink reference signal received power value) for both downlink and uplink operations, even though the second reference signal may have a better uplink reference signal received power value.

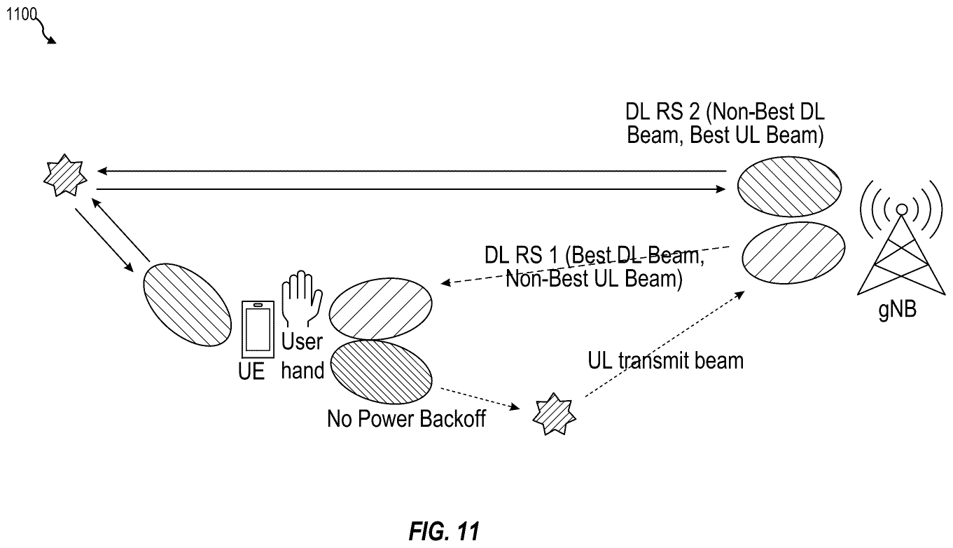

In NR, some issues due to not reporting the uplink transmission metrics to the gNB may be mitigated by UE implementation. In one implementation, the UE may only report reference signals (or beams) to the gNB that are good for both the uplink and downlink transmissions. For example, the UE may report the second reference signal and not report the first reference signal to the gNB. So, the second reference signal may be selected by the gNB for both the uplink and downlink transmissions at a cost of a degraded downlink performance. In another implementation, as illustrated in a diagram 1100 of FIG. 11, the UE may report the first reference signal (e.g., which is the best downlink beam) to the gNB, but may also use or indicate an uplink transmit beam without a power back off (e.g., which is different from the best downlink receive beam/first reference signal) to the gNB. However, such uplink transmit beam for the uplink transmissions may not always exist for the UE (e.g., the first reference signal may have a single good path).

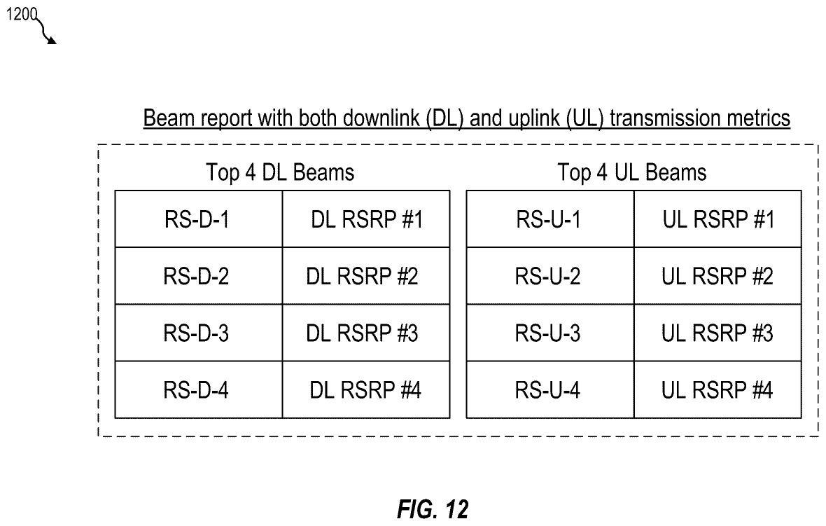

In some cases, to select best gNB beams for the uplink and downlink transmissions, uplink beam/transmission metrics may be reported in either a uplink-only beam report or a joint downlink/uplink beam report to the gNB. For example, as illustrated in a diagram 1200 of FIG. 12, in the joint downlink/uplink beam report to the gNB, the UE may report top four downlink beams (per their downlink reference signal received power values) and top four uplink beams (per their uplink reference signal received power values), based on which the gNB may select best beams for the uplink and downlink transmissions. For example, the gNB may select a first reference signal for the downlink transmissions and a second reference signal for the uplink transmissions.

In some cases, the UE may report a number of beams to the gNB, with both downlink and uplink transmission metrics per reported beam. This may done after the UE may enter a discontinuous reception (DRX) on-duration period.

To save latency and improve performance immediately after entering the DRX on-duration period, techniques proposed herein may configure the UE to generate and transmit an uplink beam report based on a wakeup signal (WUS) trigger. The uplink beam report may include beam strength of multiple beams for uplink transmissions.

For example, when decoupled downlink/uplink beams have been used recently in a previous DRX cycle and since a WUS is a group common, a single trigger may be used by the gNB for receiving uplink beam reports from multiple UEs. This may save overhead of multiple UE-specific DCI trigger within DRX on-durations of different UEs. In some cases, DRX cycles may not be aligned for different UEs.

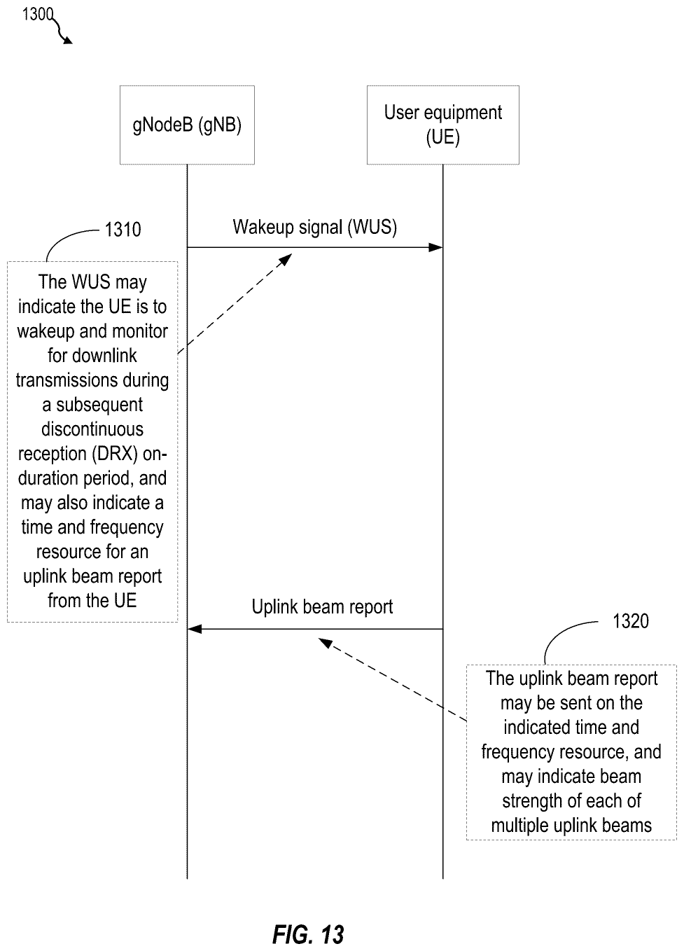

The techniques proposed herein for managing the uplink beam reports may be understood with reference to FIG. 13-FIG. 21.

FIG. 13 depicts a call flow diagram 1300 illustrating example communication among wireless nodes such as a UE and a network entity (e.g., a gNB) for managing uplink beam reports. The UE shown in FIG. 13 may be an example of the UE 104 depicted and described with respect to FIG. 1 and FIG. 3. The gNB depicted in FIG. 13 may be an example of the BS 102 depicted and described with respect to FIG. 1 and FIG. 3, or the disaggregated BS depicted and described with respect to FIG. 2.

As indicated at 1310, the gNB transmits one or more WUSs to the UE. For example, a WUS received by the UE may indicate to the UE to wakeup and monitor for downlink transmissions from the gNB during a subsequent DRX on-duration period. The WUS may also indicate one or more time and frequency resources for transmitting the uplink beam reports.

As indicated at 1320, the UE transmits an uplink beam report to the gNB, after receiving the WUS. The uplink beam report may indicate beam strength of each of multiple uplink beams (or reference signals). The report may be sent on an indicated time and frequency resource.

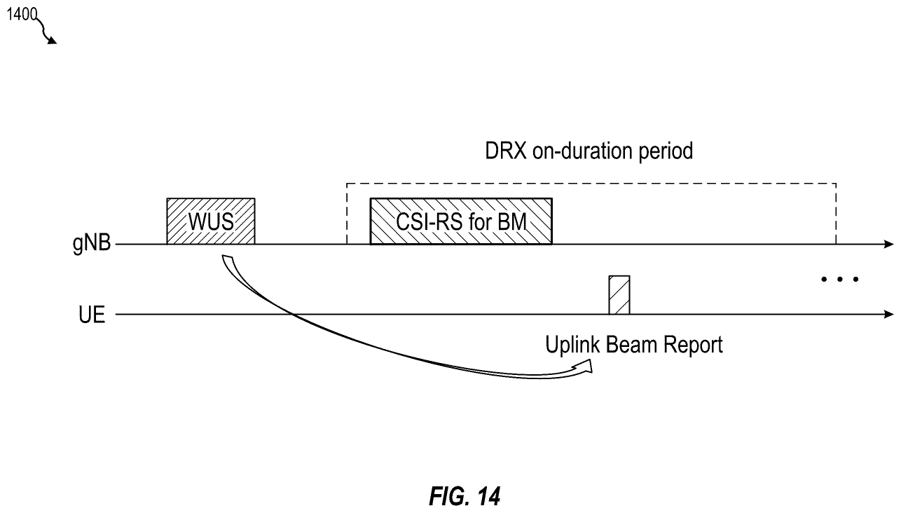

For example, as illustrated in a diagram 1400 of FIG. 14, the WUS from the gNB to the UE may trigger the UE to transmit the uplink beam report on a time and frequency resource indicated by the WUS. The UE may be configured to transmit the uplink beam report only when the WUS indicates the UE to start a DRX on-duration.

In certain aspects, the UE may calculate the beam strength of each of the multiple uplink beams based on measuring reference signal received power of each of the multiple uplink beams (or corresponding/associated reference signals). For example, the UE may receive the reference signals (e.g., on downlink beams) from the gNB. The UE may measure downlink reference signal received power of the reference signals received at the UE (e.g., on the downlink beams). The UE may also estimate (or measure) uplink reference signal received power of these same reference signals based on their expected or possible transmission from the UE to the gNB (e.g., on the uplink beams). The UE may then calculate the beam strength of each of the uplink beams based on the uplink reference signal received power of each of the one or more reference signals. For instance, the UE may calculate the beam strength of a first uplink beam based on probable uplink reference signal received power of a first reference signal from the UE to the gNB.

In certain aspects, the UE may determine an uplink beam with a highest uplink reference signal received power among the uplink beams. The UE may transmit an indication of the determined uplink beam with the highest uplink reference signal received power to the gNB. For example, the uplink beam report may include information associated with the uplink beam, which may have the highest uplink reference signal received power.

In certain aspects, the uplink beam report may include top N number of uplink beams and their uplink reference signal received power, which may be calculated by the UE based on measurement of downlink reference signals (e.g., synchronization signal blocks (SSBs)) and their associated reference signal identifications (IDs).

In certain aspects, the UE may transmit the report on a time and frequency resource associated with a lowest report configuration ID among all report configuration IDs. For example, when the WUS may not indicate any time and frequency resource for sending the uplink beam report, then the UE may implement a default rule to determine a time and frequency resource for sending the uplink beam report. The default rule may indicate to use the time and frequency resource, which may be associated with the lowest report configuration ID.

In certain aspects, the WUS may include at least one bit corresponding to a wakeup indication bit. A positive value of the wakeup indication bit may indicate the UE to transmit the uplink beam report.

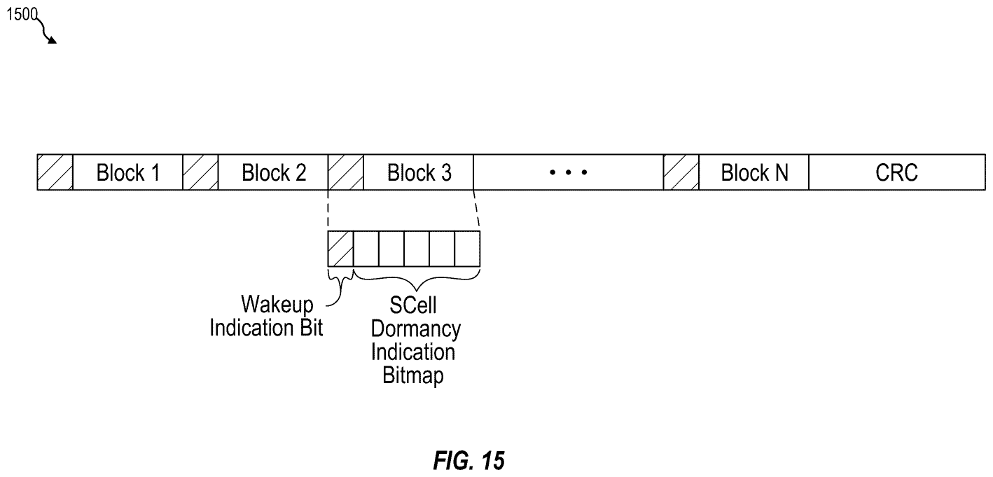

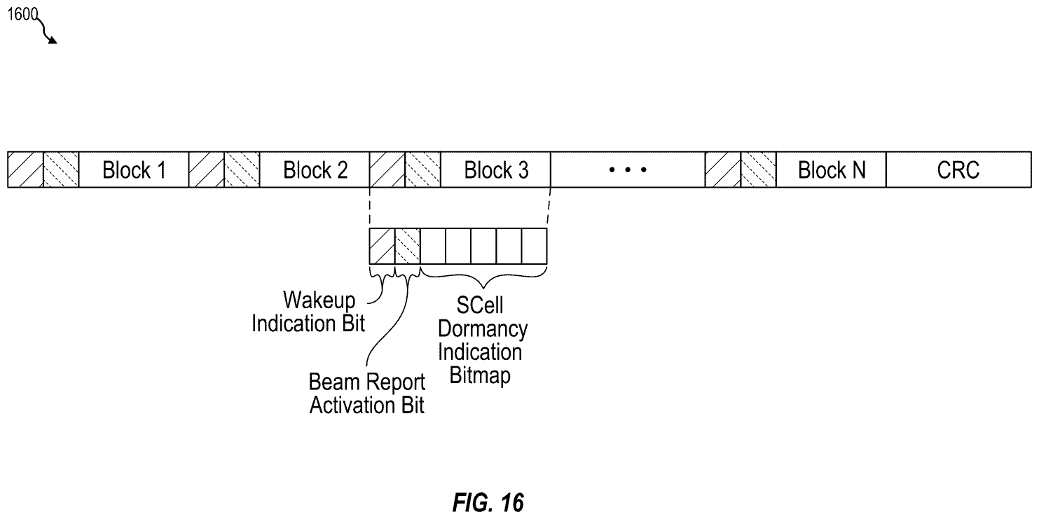

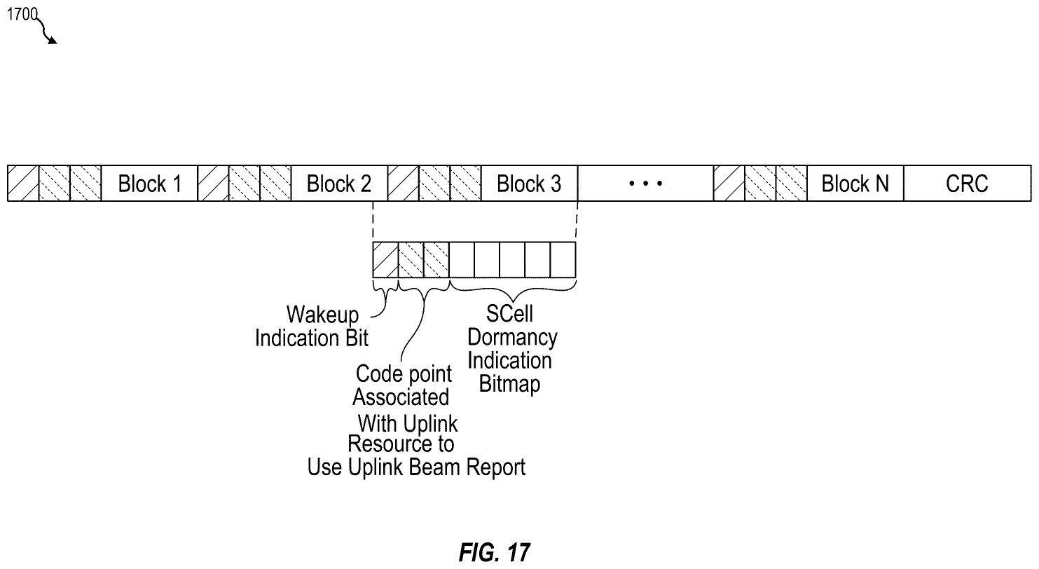

As illustrated in a diagram 1500 of FIG. 15, the WUS includes a field for the wakeup indication bit, which triggers the UE to generate and transmit the uplink beam report. For example, when a value of the wakeup indication bit may be set to one, the UE generates and transmits the uplink beam report. The WUS also includes a field for a source cell (SCell) dormancy indication bitmap.

In certain aspects, the WUS may include at least two bits, which may include a wakeup indication bit and a beam report activation bit. Positive values of the wakeup indication bit and the beam report activation bit may indicate the UE to transmit the uplink beam report.

For example, the WUS may include a field for a separate bit (e.g., the beam report activation bit and not the wakeup indication bit) that triggers the uplink beam report. The beam report activation bit may be enabled only when the wakeup indication bit is set to one. For example, as illustrated in a diagram 1600 of FIG. 16, the WUS includes fields for the wakeup indication bit and the beam report activation bit. If the wakeup indication bit is set to one, the UE then checks a status of the beam report activation bit. When the beam report activation bit is set to one, the UE generates and transmits the uplink beam report. However, when the beam report activation bit is set to zero, the UE does not transmit the uplink beam report.

In certain aspects, the WUS may include at least one code point field (e.g., per a first WUS format). The at least one code point field may indicate the one or more time and frequency resources to use for transmitting the uplink beam report. In certain aspects, a presence of the at least one code point field in the WUS may also indicate the UE to transmit the uplink beam report to the gNB.

For example, the WUS that triggers transmission of the uplink beam report by the UE may include an additional UE specific field (e.g., in addition to the wakeup indication bit), which may correspond to an uplink resource to be used by the UE for transmitting the uplink beam report. For example, as illustrated in a diagram 1700 of FIG. 17, the additional UE specific field in the WUS may be a code point, which may be associated with the uplink resource. This additional UE specific field may be similar to channel state information (CSI) trigger state (e.g., with N number of uplink resources pre-configured during a previous DRX on-duration) and the codepoint indicating which one or more pre-configured uplink resources to use for transmitting the uplink beam report.

In some cases, a presence of the additional UE specific field/code point in the WUS may also implicitly mean that the UE has to generate and transmit the uplink beam report to the gNB. The UE may then transmit the uplink beam report on the uplink resource indicated via the code point in the WUS.

In some cases, the first WUS format of the WUS may be UE-specific, which may allow a larger DCI payload size (e.g., especially in Frequency Range 2 (FR2) beam-based communication systems).

In certain aspects, the UE may calculate and determine that a beam strength of a first uplink beam indicated in a preceding uplink beam report to the gNB during a preceding DRX on-duration period is less than a first threshold value. The UE may also calculate and determine that a beam strength of a second uplink beam indicated in the preceding uplink beam report to the gNB during the preceding DRX on-duration period is higher than the beam strength of the first uplink beam by a second threshold value. In such cases, the UE may determine to transmit the uplink beam report when the beam strength of the first uplink beam is less than the first threshold and/or the beam strength of the second uplink beam is higher than the beam strength of the first uplink beam by the second threshold. In such cases, the UE may also determine to skip transmission of the uplink beam report when the beam strength of the first uplink beam is not less than the first threshold and/or the beam strength of the second uplink beam is not higher than the beam strength of the first uplink beam by the second threshold.

For example, the WUS received by the UE may trigger conditional transmission of the uplink beam report to the gNB. That is, when one or more conditions are satisfied, then the UE transmits the uplink beam report to the gNB. For instance, the gNB may configure the WUS to trigger the UE to transmit the uplink beam report when some conditions are satisfied. When the conditions are not satisfied, the UE may skip transmission of the uplink beam report on indicated uplink resources. One condition may be satisfied when one or more of uplink beam metrics (e.g., such as beam strength, etc.) for a first reference signal or uplink beam in a previous uplink beam report is worse than a configured threshold. Another condition may be satisfied when one or more of uplink beam metrics for a second reference signal or uplink beam in the previous uplink beam report is better than the one or more of uplink beam metrics for the first reference signal or uplink beam by at least a configured threshold.

### Example Method for Wireless Communications at a UE

FIG. 18 shows an example of a method 1800 for wireless communications at a wireless node for managing uplink beam reports. The wireless node is a user equipment (UE), such as the UE 104 of FIG. 1 and FIG. 3.

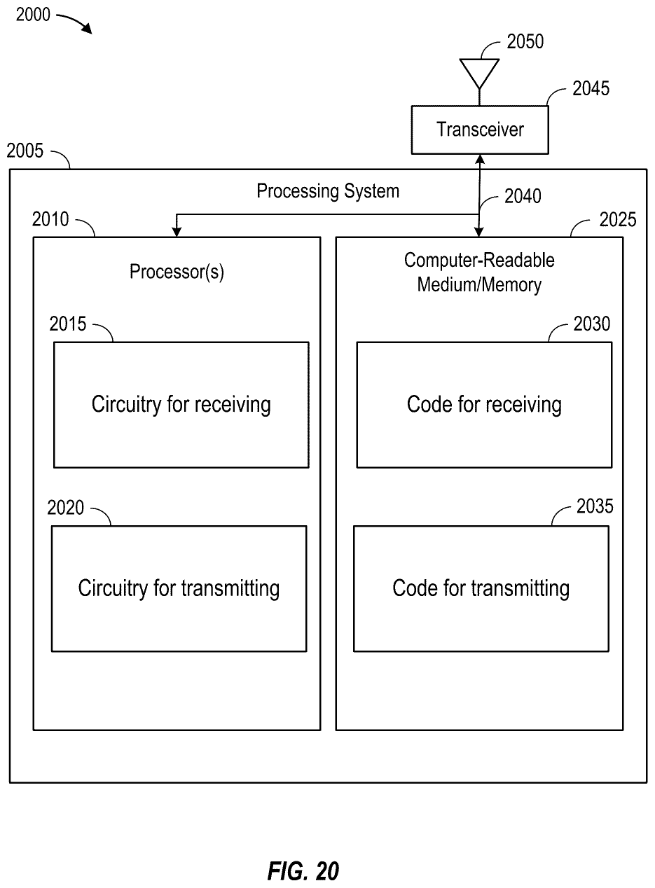

Method 1800 begins at 1810 with receiving a wakeup signal (WUS) indicating the UE is to wakeup and monitor for downlink transmissions during a subsequent discontinuous reception (DRX) on-duration period. In some cases, the operations of this step refer to, or may be performed by, circuitry for receiving and/or code for receiving as described with reference to FIG. 20.

Method 1800 then proceeds to 1820 with transmitting a report indicating beam strength of each of one or more uplink beams, in response to receiving the WUS. In some cases, the operations of this step refer to, or may be performed by, circuitry for transmitting and/or code for transmitting as described with reference to FIG. 20.

In certain aspects, the WUS indicates at least one time and frequency resource for transmitting the report.

In certain aspects, the method 1800 further includes transmitting the report on the at least one time and frequency resource.

In certain aspects, the method 1800 further includes receiving one or more reference signals; measuring downlink reference signal received power of the one or more reference signals received at the UE and estimating uplink reference signal received power of the one or more reference signals based on their expected transmission from the UE to a network entity; and calculating the beam strength of each of the one or more uplink beams based on the uplink reference signal received power of a corresponding reference signal of the one or more reference signals.

In certain aspects, the method 1800 further includes determining an uplink beam with a highest uplink reference signal received power among the one or more uplink beams.

In certain aspects, the method 1800 further includes transmitting an indication of the uplink beam with the highest uplink reference signal received power.

In certain aspects, the method 1800 further includes transmitting the report on a time and frequency resource associated with a lowest report configuration identification (ID) among all report configuration IDs.

In certain aspects, the WUS includes at least one bit corresponding to a wakeup indication bit, and a positive value of the wakeup indication bit indicates the UE to transmit the report.

In certain aspects, the WUS includes at least two bits including a wakeup indication bit and a beam report activation bit, and positive values of both the wakeup indication bit and the beam report activation bit indicate the UE to transmit the report.

In certain aspects, the WUS includes at least one code point field indicating one or more time and frequency resources to use for transmitting the report.

In certain aspects, a presence of the at least one code point field in the WUS indicates the UE to transmit the report.

In certain aspects, the method 1800 further includes determining at least one of: a beam strength of a first uplink beam indicated in a preceding report during a preceding DRX on-duration period is less than a first threshold or a beam strength of a second uplink beam is higher than the beam strength of the first uplink beam by a second threshold.

In certain aspects, the method 1800 further includes transmitting the report when at least one of: the beam strength of the first uplink beam is less than the first threshold or the beam strength of the second uplink beam is higher than the beam strength of the first uplink beam by the second threshold.

In certain aspects, the method 1800 further includes determining to skip transmission of the report when at least one of: the beam strength of the first uplink beam is not less than the first threshold or the beam strength of the second uplink beam is not higher than the beam strength of the first uplink beam by the second threshold.

In one aspect, the method 1800, or any aspect related to it, may be performed by an apparatus, such as a communications device 2000 of FIG. 20, which includes various components operable, configured, or adapted to perform the method 1800. The communications device 2000 is described below in further detail.

Note that FIG. 18 is just one example of a method, and other methods including fewer, additional, or alternative steps are possible consistent with this disclosure.

### Example Method for Wireless Communications at a Network Entity

FIG. 19 shows an example of a method 1900 for wireless communications at a wireless node for managing uplink beam reports. The wireless node is a network entity, such as the BS 102 of FIG. 1 and FIG. 3.

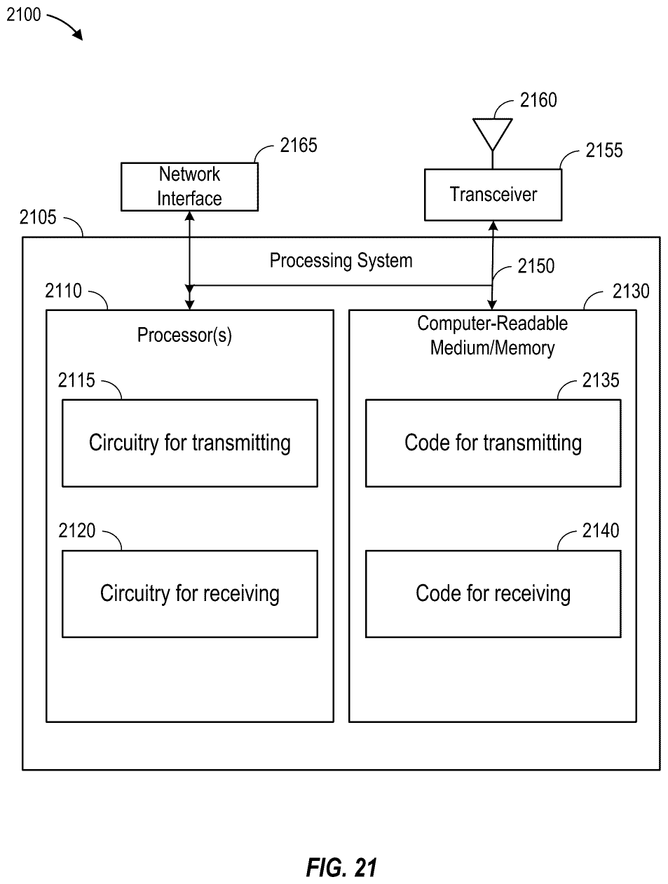

Method 1900 begins at 1910 with transmitting a wakeup signal (WUS) indicating a user equipment (UE) is to wakeup and monitor for downlink transmissions during a subsequent discontinuous reception (DRX) on-duration period. In some cases, the operations of this step refer to, or may be performed by, circuitry for transmitting and/or code for transmitting as described with reference to FIG. 21.

Method 1900 then proceeds to 1920 with receiving a report indicating beam strength of each of one or more uplink beams, in response to transmitting the WUS. In some cases, the operations of this step refer to, or may be performed by, circuitry for receiving and/or code for receiving as described with reference to FIG. 21.

In certain aspects, the WUS indicates at least one time and frequency resource for transmitting the report.

In certain aspects, the method 1900 further includes receiving the report on the at least one time and frequency resource.

In certain aspects, the method 1900 further includes receiving the report on a time and frequency resource associated with a lowest report configuration identification (ID) among all report configuration IDs.

In certain aspects, the WUS includes at least one bit corresponding to a wakeup indication bit, and wherein a positive value of the wakeup indication bit indicates the UE to transmit the report.

In certain aspects, the WUS includes at least two bits including a wakeup indication bit and a beam report activation bit, and wherein positive values of both the wakeup indication bit and the beam report activation bit indicate the UE to transmit the report.

In certain aspects, the WUS includes at least one code point field indicating one or more time and frequency resources to use for transmitting the report.

In certain aspects, a presence of the at least one code point field in the WUS indicates the UE to transmit the report.

In one aspect, the method 1900, or any aspect related to it, may be performed by an apparatus, such as a communications device 2100 of FIG. 21, which includes various components operable, configured, or adapted to perform the method 1900. The communications device 2100 is described below in further detail.

Note that FIG. 19 is just one example of a method, and other methods including fewer, additional, or alternative steps are possible consistent with this disclosure.

### Example Communications Devices

FIG. 20 depicts aspects of an example communications device 2000 managing uplink beam reports. In some aspects, communications device 2000 is a user equipment (UE), such as UE 104 described above with respect to FIG. 1 and FIG. 3.

The communications device 2000 includes a processing system 2005 coupled to a transceiver 2045 (e.g., a transmitter and/or a receiver). The transceiver 2045 is configured to transmit and receive signals for the communications device 2000 via an antenna 2050, such as the various signals as described herein. The processing system 2005 may be configured to perform processing functions for the communications device 2000, including processing signals received and/or to be transmitted by the communications device 2000.

The processing system 2005 includes one or more processors 2010. In various aspects, the one or more processors 2010 may be representative of one or more of receive processor 358, transmit processor 364, TX MIMO processor 366, and/or controller/processor 380, as described with respect to FIG. 3. The one or more processors 2010 are coupled to a computer-readable medium/memory 2025 via a bus 2040. In certain aspects, the computer-readable medium/memory 2025 is configured to store instructions (e.g., computer-executable code) that when executed by the one or more processors 2010, cause the one or more processors 2010 to perform the method 1800 described with respect to FIG. 28, and/or any aspect related to it. Note that reference to a processor performing a function of communications device 2000 may include the one or more processors 2010 performing that function of communications device 2000.

In the depicted example, computer-readable medium/memory 2025 stores code (e.g., executable instructions), such as code for transmitting 2035 and code for receiving 2030. Processing of the code for transmitting 2035 and the code for receiving 2030 may cause the communications device 2000 to perform the method 1800 described with respect to FIG. 18, and/or any aspect related to it.

The one or more processors 2010 include circuitry configured to implement (e.g., execute) the code stored in the computer-readable medium/memory 2025, including circuitry such as circuitry for transmitting 2020 and circuitry for receiving 2015. Processing with the circuitry for transmitting 2020 and the circuitry for receiving 2015 may cause the communications device 2000 to perform the method 1800 described with respect to FIG. 18, and/or any aspect related to it.

Various components of the communications device 2000 may provide means for performing the method 1800 described with respect to FIG. 18, and/or any aspect related to it.

Means for transmitting, sending or outputting (e.g., for transmission) may include transceivers 354 and/or antenna(s) 352 of the UE 104 illustrated in FIG. 3 and/or the code for transmitting 2035, the circuitry for transmitting 2020, the transceiver 2045 and the antenna 2050 of the communications device 2000 in FIG. 20.

Means for receiving or obtaining may include transceivers 354 and/or antenna(s) 352 of the UE 104 illustrated in FIG. 3 and/or the code for receiving 2030, the circuitry for receiving 2015, the transceiver 2045 and the antenna 2050 of the communications device 2000 in FIG. 20.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 20 is an example, and many other examples and configurations of communication device 2000 are possible.

FIG. 21 depicts aspects of an example communications device 2100 managing uplink beam reports. In some aspects, communications device 2100 is a network entity, such as BS 102 of FIG. 1 and FIG. 3, or a disaggregated base station as discussed with respect to FIG. 2.

The communications device 2100 includes a processing system 2105 coupled to a transceiver 2155 (e.g., a transmitter and/or a receiver) and/or a network interface 2165. The transceiver 2155 is configured to transmit and receive signals for the communications device 2100 via an antenna 2160, such as the various signals as described herein. The network interface 2165 is configured to obtain and send signals for the communications device 2100 via communication link(s), such as a backhaul link, midhaul link, and/or fronthaul link as described herein, such as with respect to FIG. 2. The processing system 2105 may be configured to perform processing functions for the communications device 2100, including processing signals received and/or to be transmitted by the communications device 2100.

The processing system 2105 includes one or more processors 2110. In various aspects, one or more processors 2110 may be representative of one or more of receive processor 338, transmit processor 320, TX MIMO processor 330, and/or controller/processor 340, as described with respect to FIG. 3. The one or more processors 2110 are coupled to a computer-readable medium/memory 2130 via a bus 2150. In certain aspects, the computer-readable medium/memory 2130 is configured to store instructions (e.g., computer-executable code) that when executed by the one or more processors 2110, cause the one or more processors 2110 to perform the method 1900 described with respect to FIG. 19, or any aspect related to it. Note that reference to a processor of communications device 2100 performing a function may include the one or more processors 2110 of communications device 2100 performing that function.

In the depicted example, the computer-readable medium/memory 2130 stores code (e.g., executable instructions), such as code for receiving 2140 and code for transmitting 2135. Processing of the code for receiving 2140 and the code for transmitting 2135 may cause the communications device 2100 to perform the method 1900 described with respect to FIG. 19, or any aspect related to it.

The one or more processors 2110 include circuitry configured to implement (e.g., execute) the code stored in the computer-readable medium/memory 2130, including circuitry such as circuitry for receiving 2120 and circuitry for transmitting 2115. Processing with the circuitry for receiving 2120 and the circuitry for transmitting 2115 may cause the communications device 2100 to perform the method 1900 described with respect to FIG. 19, or any aspect related to it.

Various components of the communications device 2100 may provide means for performing the method 1900 described with respect to FIG. 19, or any aspect related to it.

Means for transmitting, sending or outputting for transmission may include transceivers 332 and/or antenna(s) 334 of the BS 102 illustrated in FIG. 3 and/or the circuitry for transmitting 2115, the code for transmitting 2135, the transceiver 2155 and the antenna 2160 of the communications device 2100 in FIG. 21.

Means for receiving or obtaining may include transceivers 332 and/or antenna(s) 334 of the BS 102 illustrated in FIG. 3 and/or the circuitry for receiving 2120, the code for receiving 2140, the transceiver 2155 and the antenna 2160 of the communications device 2100 in FIG. 21.

In some cases, rather than actually transmitting, for example, signals and/or data, a device may have an interface to output signals and/or data for transmission (a means for outputting). For example, a processor may output signals and/or data, via a bus interface, to an RF front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 21 is an example, and many other examples and configurations of communication device 2100 are possible.

### Example Clauses

Implementation examples are described in the following numbered clauses:
Clause 1: A method for wireless communications at a user equipment (UE), comprising: receiving a wakeup signal (WUS) indicating the UE is to wakeup and monitor for downlink transmissions during a subsequent discontinuous reception (DRX) on-duration period; and transmitting a report indicating beam strength of each of one or more uplink beams, in response to receiving the WUS.
Clause 2: The method of clause 1, wherein: the WUS indicates at least one time and frequency resource for transmitting the report; and the transmitting comprises transmitting the report on the at least one time and frequency resource.
Clause 3: The method of any one of clauses 1-2, further comprising receiving one or more reference signals; measuring downlink reference signal received power of the one or more reference signals received at the UE and estimating uplink reference signal received power of the one or more reference signals based on their expected transmission from the UE to a network entity; and calculating the beam strength of each of the one or more uplink beams based on the uplink reference signal received power of a corresponding reference signal of the one or more reference signals.
Clause 4: The method of clause 3, further comprising: determining an uplink beam with a highest uplink reference signal received power among the one or more uplink beams; and transmitting an indication of the uplink beam with the highest uplink reference signal received power.
Clause 5: The method of any one of clauses 1-4, wherein the transmitting comprises transmitting the report on a time and frequency resource associated with a lowest report configuration identification (ID) among all report configuration IDs.
Clause 6: The method of any one of clauses 1-5, wherein the WUS comprises at least one bit corresponding to a wakeup indication bit, and wherein a positive value of the wakeup indication bit indicates the UE to transmit the report.
Clause 7: The method of any one of clauses 1-6, wherein the WUS comprises at least two bits including a wakeup indication bit and a beam report activation bit, and wherein positive values of both the wakeup indication bit and the beam report activation bit indicate the UE to transmit the report.
Clause 8: The method of any one of clauses 1-7, wherein the WUS comprises at least one code point field indicating one or more time and frequency resources to use for transmitting the report.
Clause 9: The method of clause 8, wherein a presence of the at least one code point field in the WUS indicates the UE to transmit the report.
Clause 10: The method of any one of clauses 1-9, further comprising: determining at least one of: a beam strength of a first uplink beam indicated in a preceding report during a preceding DRX on-duration period is less than a first threshold or a beam strength of a second uplink beam is higher than the beam strength of the first uplink beam by a second threshold; and the transmitting comprises transmitting the report when at least one of: the beam strength of the first uplink beam is less than the first threshold or the beam strength of the second uplink beam is higher than the beam strength of the first uplink beam by the second threshold.
Clause 11: The method of clause 10, further comprising determining to skip transmission of the report when at least one of: the beam strength of the first uplink beam is not less than the first threshold or the beam strength of the second uplink beam is not higher than the beam strength of the first uplink beam by the second threshold.
Clause 12: A method for wireless communications at a network entity, comprising: transmitting a wakeup signal (WUS) indicating a user equipment (UE) is to wakeup and monitor for downlink transmissions during a subsequent discontinuous reception (DRX) on-duration period; and receiving a report indicating beam strength of each of one or more uplink beams, in response to transmitting the WUS.
Clause 13: The method of clause 12, wherein: the WUS indicates at least one time and frequency resource for transmitting the report; and the receiving comprises receiving the report on the at least one time and frequency resource.
Clause 14: The method of any one of clauses 12-13, wherein the receiving comprises receiving the report on a time and frequency resource associated with a lowest report configuration identification (ID) among all report configuration IDs.
Clause 15: The method of any one of clauses 12-14, wherein the WUS comprises at least one bit corresponding to a wakeup indication bit, and wherein a positive value of the wakeup indication bit indicates the UE to transmit the report.
Clause 16: The method of any one of clauses 12-15, wherein the WUS comprises at least two bits including a wakeup indication bit and a beam report activation bit, and wherein positive values of both the wakeup indication bit and the beam report activation bit indicate the UE to transmit the report.
Clause 17: The method of any one of clauses 12-16, wherein the WUS comprises at least one code point field indicating one or more time and frequency resources to use for transmitting the report.
Clause 18: The method of clause 17, wherein a presence of the at least one code point field in the WUS indicates the UE to transmit the report.
Clause 19: An apparatus, comprising: a memory comprising executable instructions; and one or more processors configured, individually or in any combination, to execute the executable instructions and cause the apparatus to perform a method in accordance with any one of Clauses 1-18.
Clause 20: An apparatus, comprising means for performing a method in accordance with any one of Clauses 1-18.
Clause 21: A non-transitory computer-readable medium comprising executable instructions that, when executed by one or more processors of an apparatus, cause the apparatus to perform a method in accordance with any one of Clauses 1-18.
Clause 22: A computer program product embodied on a computer-readable storage medium comprising code for performing a method in accordance with any one of Clauses 1-18.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining”may include resolving, selecting, choosing, establishing and the like.

As used herein, the term wireless node may refer to, for example, a network entity or a UE. In this context, a network entity may be a base station (e.g., a gNB) or a module (e.g., a CU, DU, and/or RU) of a disaggregated base station.

While the present disclosure may describe certain operations as being performed by one type of wireless node, the same or similar operations may also be performed by another type of wireless node. For example, operations performed by a network entity may also (or instead) be performed by a UE. Similarly, operations performed by a UE may also (or instead) be performed by a network entity.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more. ” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a user equipment (UE), comprising:
at least one memory comprising instructions; and
one or more processors, individually or collectively, configured to execute the instructions and cause the apparatus to:
receive a wakeup signal (WUS) indicating the UE is to wakeup and monitor for downlink transmissions during a subsequent discontinuous reception (DRX) on-duration period; and
transmit a report indicating beam strength of each of one or more uplink beams, in response to receiving the WUS.

2. The apparatus of claim 1, wherein:
the WUS indicates at least one time and frequency resource for transmitting the report; and
the transmit comprises transmit the report on the at least one time and frequency resource.

3. The apparatus of claim 1, wherein the one or more processors, individually or collectively, are configured to execute the instructions and cause the apparatus to:
receive one or more reference signals;
measure downlink reference signal received power of the one or more reference signals received at the UE and estimate uplink reference signal received power of the one or more reference signals based on their expected transmission from the UE to a network entity; and
calculate the beam strength of each of the one or more uplink beams based on the uplink reference signal received power of a corresponding reference signal of the one or more reference signals.

4. The apparatus of claim 3, wherein the one or more processors, individually or collectively, are configured to execute the instructions and cause the apparatus to:
determine an uplink beam with a highest uplink reference signal received power among the one or more uplink beams; and
transmit an indication of the uplink beam with the highest uplink reference signal received power.

5. The apparatus of claim 1, wherein the transmit comprises transmit the report on a time and frequency resource associated with a lowest report configuration identification (ID) among all report configuration IDs.

6. The apparatus of claim 1, wherein the WUS comprises at least one bit corresponding to a wakeup indication bit, and wherein a positive value of the wakeup indication bit indicates the UE to transmit the report.

7. The apparatus of claim 1, wherein the WUS comprises at least two bits comprising a wakeup indication bit and a beam report activation bit, and wherein positive values of both the wakeup indication bit and the beam report activation bit indicate the UE to transmit the report.

8. The apparatus of claim 1, wherein the WUS comprises at least one code point field indicating one or more time and frequency resources to use for transmitting the report.

9. The apparatus of claim 8, wherein a presence of the at least one code point field in the WUS indicates the UE to transmit the report.

10. The apparatus of claim 1, wherein the one or more processors, individually or collectively, are configured to execute the instructions and cause the apparatus to:
determine at least one of: a beam strength of a first uplink beam indicated in a preceding report during a preceding DRX on-duration period is less than a first threshold or a beam strength of a second uplink beam is higher than the beam strength of the first uplink beam by a second threshold; and
transmit the report when at least one of: the beam strength of the first uplink beam is less than the first threshold or the beam strength of the second uplink beam is higher than the beam strength of the first uplink beam by the second threshold.

11. The apparatus of claim 10, wherein the one or more processors, individually or collectively, are configured to execute the instructions and cause the apparatus to determine to skip transmission of the report when at least one of: the beam strength of the first uplink beam is not less than the first threshold or the beam strength of the second uplink beam is not higher than the beam strength of the first uplink beam by the second threshold.

12. An apparatus for wireless communications at a network entity, comprising:
at least one memory comprising instructions; and
one or more processors, individually or collectively, configured to execute the instructions and cause the apparatus to:
transmit a wakeup signal (WUS) indicating a user equipment (UE) is to wakeup and monitor for downlink transmissions during a subsequent discontinuous reception (DRX) on-duration period; and
receive a report indicating beam strength of each of one or more uplink beams, in response to transmitting the WUS.

13. The apparatus of claim 12, wherein:
the WUS indicates at least one time and frequency resource for transmitting the report; and
the receive comprises receive the report on the at least one time and frequency resource.

14. The apparatus of claim 12, wherein the receive comprises receive the report on a time and frequency resource associated with a lowest report configuration identification (ID) among all report configuration IDs.

15. The apparatus of claim 12, wherein the WUS comprises at least one bit corresponding to a wakeup indication bit, and wherein a positive value of the wakeup indication bit indicates the UE to transmit the report.

16. The apparatus of claim 12, wherein the WUS comprises at least two bits comprising a wakeup indication bit and a beam report activation bit, and wherein positive values of both the wakeup indication bit and the beam report activation bit indicate the UE to transmit the report.

17. The apparatus of claim 12, wherein the WUS comprises at least one code point field indicating one or more time and frequency resources to use for transmitting the report.

18. The apparatus of claim 17, wherein a presence of the at least one code point field in the WUS indicates the UE to transmit the report.

19. A method for wireless communications at a user equipment (UE), comprising:
receiving a wakeup signal (WUS) indicating the UE is to wakeup and monitor for downlink transmissions during a subsequent discontinuous reception (DRX) on-duration period; and
transmitting a report indicating beam strength of each of one or more uplink beams, in response to receiving the WUS.

20. The method of claim 19, wherein:
the WUS indicates at least one time and frequency resource for transmitting the report; and
the transmitting comprises transmitting the report on the at least one time and frequency resource.

21. The method of claim 19, further comprising:
receiving one or more reference signals;
measuring downlink reference signal received power of the one or more reference signals received at the UE and estimating uplink reference signal received power of the one or more reference signals based on their expected transmission from the UE to a network entity; and
calculating the beam strength of each of the one or more uplink beams based on the uplink reference signal received power of a corresponding reference signal of the one or more reference signals.

22. The method of claim 21, further comprising:
determining an uplink beam with a highest uplink reference signal received power among the one or more uplink beams; and
transmitting an indication of the uplink beam with the highest uplink reference signal received power.

23. The method of claim 19, wherein the transmitting comprises transmitting the report on a time and frequency resource associated with a lowest report configuration identification (ID) among all report configuration IDs.

24. The method of claim 19, wherein the WUS comprises at least one bit corresponding to a wakeup indication bit, and wherein a positive value of the wakeup indication bit indicates the UE to transmit the report.

25. The method of claim 19, wherein the WUS comprises at least two bits comprising a wakeup indication bit and a beam report activation bit, and wherein positive values of both the wakeup indication bit and the beam report activation bit indicate the UE to transmit the report.

26. The method of claim 19, wherein the WUS comprises at least one code point field indicating one or more time and frequency resources to use for transmitting the report.

27. The method of claim 26, wherein a presence of the at least one code point field in the WUS indicates the UE to transmit the report.

28. A method for wireless communications at a network entity, comprising:
transmitting a wakeup signal (WUS) indicating a user equipment (UE) is to wakeup and monitor for downlink transmissions during a subsequent discontinuous reception (DRX) on-duration period; and
receiving a report indicating beam strength of each of one or more uplink beams, in response to transmitting the WUS.

29. The method of claim 28, wherein:
the WUS indicates at least one time and frequency resource for transmitting the report; and
the receiving comprises receiving the report on the at least one time and frequency resource.

30. The method of claim 28, wherein the receiving comprises receiving the report on a time and frequency resource associated with a lowest report configuration identification (ID) among all report configuration IDs.
